(19) United States
(12) Patent Application Publication
(10) Pub. No.: US 2025/0353449 A1
(43) Pub. Date: Nov. 20, 2025

(54) Vehicle Dashboard and Console-Mounted Phone Holder Assembly

(71) Applicant: Aleksey Devyatkin, Flemington, NJ (US)

(72) Inventor: Aleksey Devyatkin, Flemington, NJ (US)

(21) Appl. No.: 19/286,216

(22) Filed: Jul. 30, 2025

(51) Int. Cl. B60R 11/02; B60R 11/00

(52) U.S. Cl. CPC B60R 11/0241; B60R 2011/0005; B60R 2011/0007; B60R 2011/0056; B60R 2011/0057; B60R 2011/0059; B60R 2011/0063; B60R 2011/007

(57) ABSTRACT

A customizable, vehicle-specific device holder assembly for dashboards and center consoles is disclosed. The assembly comprises a bracket with one or more contact surfaces configured to engage interior vehicle structures using non-invasive mounting interfaces. These may include pressure-sensitive adhesives, removable pads, hook-and-loop fasteners, mechanical clips, or magnetic interfaces. The design allows secure installation without suction cups, vent clips, or permanent hardware. The holder may support phones, tablets, or other electronic devices, and may be removable, adjustable, or semi-permanently affixed. Variants can be customized for diverse vehicle geometries.

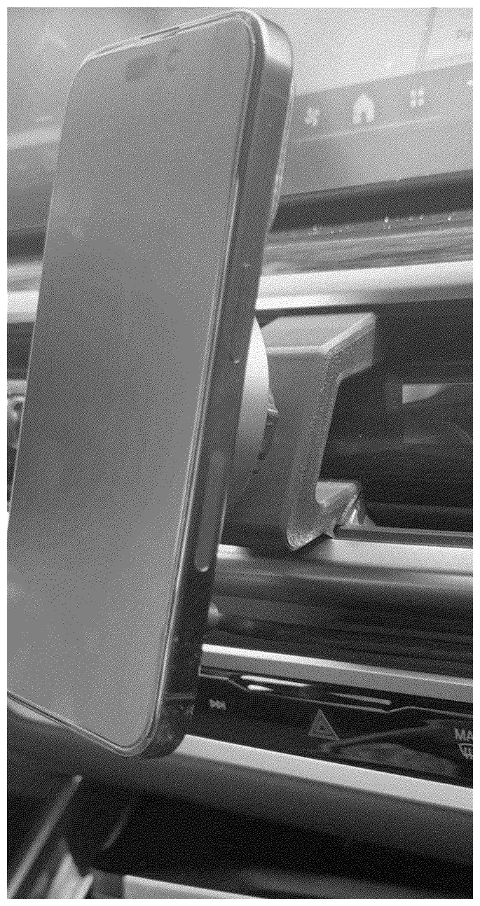

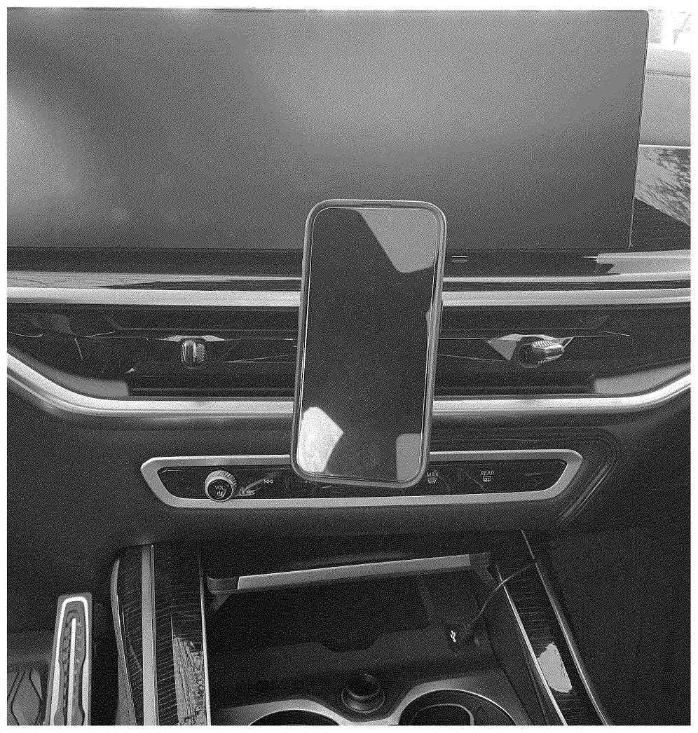

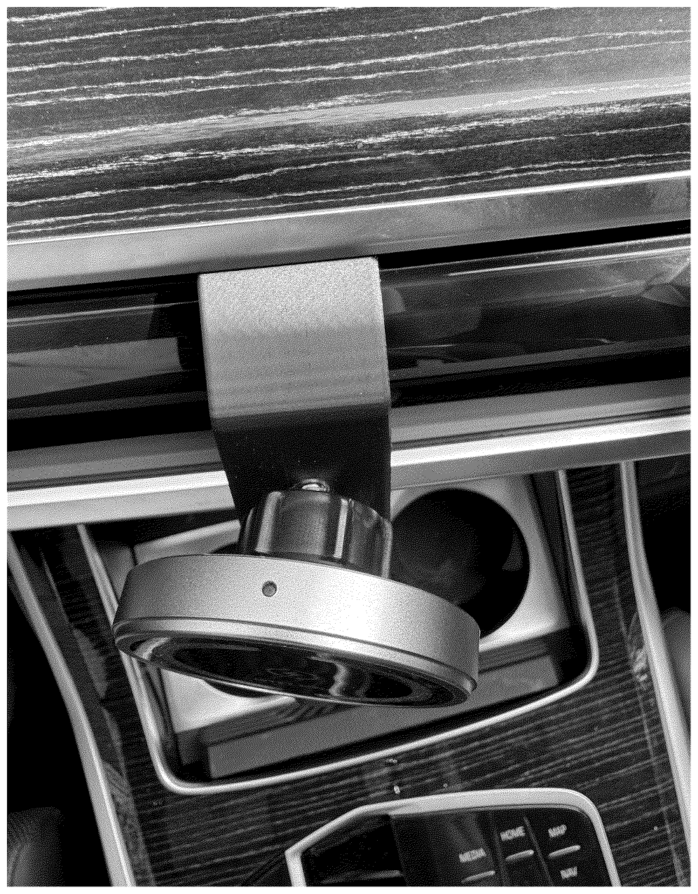

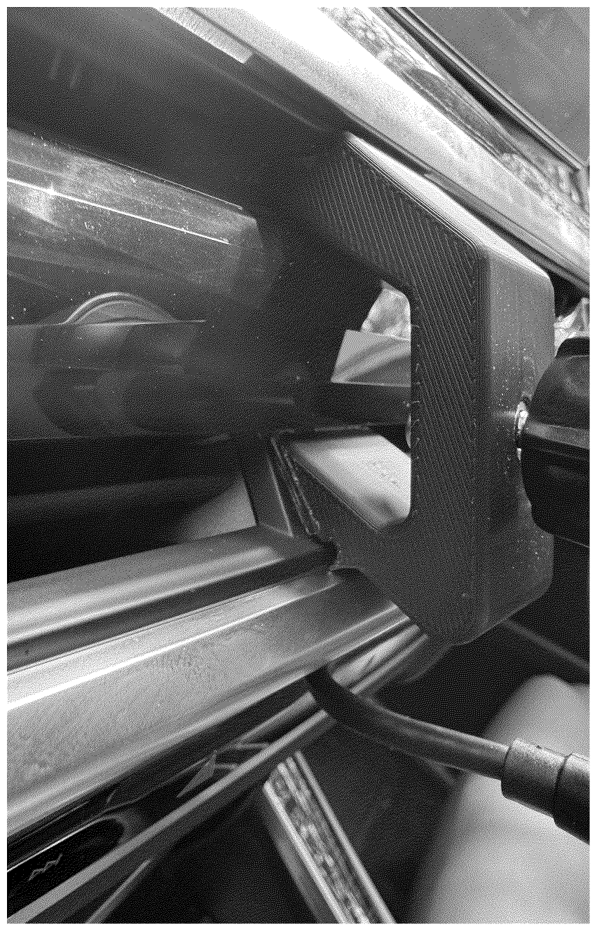

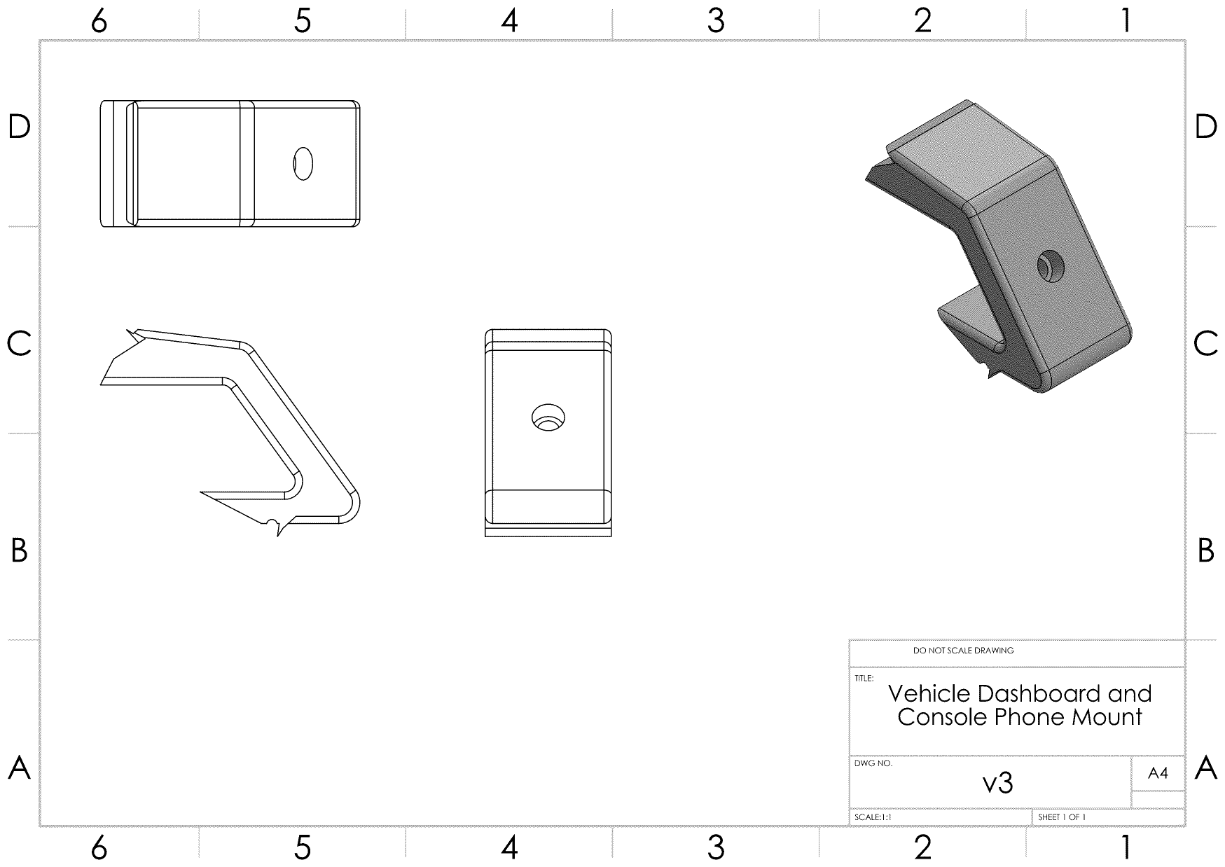

### CROSS-REFERENCE TO RELATED APPLICATIONS

None.

### BACKGROUND OF THE INVENTION

### 1. Field of the Invention

This invention relates generally to mounting devices for mobile phones and other small electronic devices, and more particularly to a vehicle-specific holder assembly designed for dashboards and center consoles where conventional mounting methods are impractical.

### 2. Description of Related Art

Many newer vehicles, particularly model years 2023 and later, including both gas-powered and electric vehicles, feature dashboards and center consoles with highly integrated and futuristic designs. These modern interiors often eliminate traditional mounting points used by existing phone holder products.

Vent-mounted holders are incompatible with non-standard or angled vent geometries, suction-cup mounts fail to adhere securely to curved or textured dashboard surfaces, and CD-slot or cup-holder mounts are impractical or obstructive given modern center console layouts.

As a result, drivers are often left without a secure and ergonomic place to mount a mobile phone for navigation or hands-free use. The need exists for vehicle-specific, non-invasive mounting solutions that are tailored to each dashboard and console design, while also adaptable for various devices and user preferences.

### SUMMARY OF THE INVENTION

The present invention provides a device holder assembly that can be mounted in vehicles lacking conventional mounting points. It is configured to engage the dashboard or center console using one or more non-invasive attachment mechanisms, such as pressure-sensitive adhesives, removable pads, hook-and-loop fasteners, or mechanical clips.

Unlike vent-mounted, suction-based, or screw-fastened solutions, the present assembly is customizable for specific dashboard and console geometries, yet relies on non-destructive, reversible installation.

In a preferred embodiment, the bracket is secured using two spaced-apart adhesive contact points that provide stability against vibration and sudden movements. However, single-point, three-point, or multi-point variants are contemplated.

Key advantages include secure attachment using non-invasive mounting; compatibility with dashboards and consoles of modern vehicles where other solutions fail; a bracket design that distributes load evenly and maintains device visibility; configurations adaptable for phones, GPS units, tablets, and similar electronic devices; and optional removable and semi-permanent versions.

While specific embodiments are described herein, various modifications and equivalents may be used without departing from the scope of the invention. The mounting concept is intended to be adaptable to various vehicle configurations and device types.

### BRIEF DESCRIPTION OF THE DRAWINGS

Mount Photos.pdf contains photographs of the complete assembly (mount installed on a dashboard) and includes the following:

A photograph of the complete assembly showing the mount installed on the dashboard.

A front view photograph of the assembly in its mounted configuration.

A top view photograph showing the mounting location in one of the vehicles.

A side view photograph of the assembly in its mounted configuration.

Drawing.pdf contains line drawings of the mount only, showing:

A front view of the mount.

A top view of the mount

A side view of the mount.

An asymmetric (perspective) view of the mount

### DETAILED DESCRIPTION OF THE PREFERRED AND ALTERNATIVE EMBODIMENTS

The device holder assembly comprises a bracket body having one or more contact surfaces. Each contact surface may include or be associated with a non-invasive mounting interface, which may include but is not limited to pressure-sensitive adhesive (automotive-grade double-sided tape, foam adhesive tape, gel pads), removable adhesive pads designed for dashboard materials, hook-and-loop fasteners, mechanical clips or wedges that grip trim gaps without damaging vehicle surfaces, or magnetic coupling elements used with adhesive base plates.

Adhesive and Contact Point Configurations: While a preferred embodiment employs two spaced-apart adhesive contact points, alternative configurations are contemplated, including a single large contact surface for dashboards with limited real estate, three or more contact surfaces for heavier devices or enhanced vibration resistance, and mixed adhesive-and-clip attachment methods.

Vehicle-Specific Customization: The embodiment illustrated in the accompanying Mount Photos.pdf is dimensioned specifically for the BMW X5, X6, and X7 dashboards and center consoles. These vehicles represent one category of dashboards where conventional mounting methods fail. However, the invention is not limited to these models. Similar assemblies can be custom-fit to any vehicle dashboard or console geometry, including curved, angled, or textured surfaces. Variations in bracket shape, angle, and attachment surface location may be made without departing from the core concept.

Removable and Semi-Permanent Versions: The assembly can be designed for removable use—allowing the user to remove the mount without permanent marks or damage, which is ideal for leased vehicles—or for semi-permanent or permanent use by employing higher-bond adhesives or concealed fasteners for users who prefer fixed installations.

Device Support and Adjustability: The bracket body may include a cradle portion for securely holding phones or GPS units; magnetic or mechanical interfaces for fast device attachment and removal; adjustable-angle arms to suit driver visibility and reach; and removable or interchangeable cradle heads for various device sizes.

Materials and Design Variations: The bracket may be formed from injection-molded plastic, metal, composite, or hybrid materials. Adhesive pads may be interchangeable and replaceable after wear. Structural ribs or reinforcements may be added to prevent flexing. Low-profile aesthetic designs may be used to integrate with luxury vehicle interiors.

The invention may be embodied in other specific forms and configurations without departing from its essential characteristics. The described embodiments are to be considered in all respects as illustrative and not restrictive. For example, different adhesives, surface geometries, or installation orientations may be substituted as appropriate.

1. A device mounting assembly for placement on a vehicle dashboard or center console comprising: a bracket having one or more contact surfaces configured to engage one or more portions of the dashboard or console; a non-invasive mounting interface at the one or more contact surfaces, the mounting interface selected from the group consisting of pressure-sensitive adhesive, removable adhesive pads, hook-and-loop pads, mechanical clips, magnetic couplings, or equivalents; and wherein the bracket secures a mobile device without use of suction cups, vent clips, permanent fasteners, or other invasive mounting techniques.

2. The assembly of claim 1, wherein the one or more contact surfaces comprise two spaced-apart adhesive contact points.

3. The assembly of claim 1, wherein the one or more contact surfaces comprise a single, large adhesive contact point.

4. The assembly of claim 1, wherein the one or more contact surfaces comprise three or more contact points.

5. The assembly of claim 1, wherein the bracket is configured to be removably installed without damaging the dashboard or console.

6. The assembly of claim 1, wherein the bracket is configured for semi-permanent or permanent installation using higher-strength adhesives or concealed fasteners.

7. The assembly of claim 1, wherein the bracket body includes a cradle or magnetic interface for supporting the mobile device.

8. The assembly of claim 1, wherein the bracket is customized for dashboards and consoles of specific vehicle models.

9. The assembly of claim 1, wherein the bracket includes adjustable-angle arms.

10. The assembly of claim 1, wherein the assembly is adapted to support devices selected from the group consisting of phones, GPS units, tablets, and similar electronic devices.
